(19) United States
(12) Patent Application Publication
(10) Pub. No.: US 2002/0186826 A1
(43) Pub. Date: Dec. 12, 2002

(54) Intelligent dynamic realtime feature delivery

(76) Inventors: Wen-Ling Hsu, Bridgewater, NJ (US); Ronald Sherman, Livingston, NJ (US); Ted Stine, Belle Mead, NJ (US); John G. Ramage, Westfield, NJ (US)

Correspondence Address: MORGAN & FINNEGAN, L.L.P., 345 Park Avenue, New York, NY, 10154-0053, US

(21) Appl. No.: 09/858,974

(22) Filed: May 16, 2001

(51) Int. Cl. H04M 3/42

(52) U.S. Cl. 379/201.01

(57) ABSTRACT

A system and method for offering a service upgrade to a service user. The system includes a server that monitors utilization by the user and evaluates the user's utilization pattern to determine which, if any, service upgrades may be appropriate for the user. Once a set of candidate service upgrades has been identified, the server then determines whether there is sufficient available capacity to accommodate the provision of such additional services. If such capacity exists, the user is offered the service upgrade. Since the offer is not made unless there is shown to be sufficient available capacity, once the offer is made, the system is able to implement the upgrade in real time with the user's approval.

### FIELD OF THE INVENTION

This invention relates generally to upgrading a service feature available to a service user, and more particularly, to automating aspects of offering a service upgrade to a service user based on an evaluation of the service user's utilization history and the system capacity.

### BACKGROUND OF THE INVENTION

Many service markets are characterized by the ready ability of the service provider to alter some aspect of the quality or to increase the quantity of the services made available to a user. Examples of such service markets include those for telephone, cable, Internet, and information subscriptions, among many others. These markets also tend to be characterized by keen competition and vigorous marketing efforts aimed at persuading users to switch service providers. Within the telephone service market, examples of such quality upgrades include upgrading from conventional analog service to a digital subscriber line (DSL) or an asynchronous digital subscriber line (ADSL). Similarly, in the market for cellular telephones, a user might be offered a greater quantity of prepaid minutes of service per month included in a particular calling plan. Of course, users who consent to such “improvements” or increases in quantities of prepaid services will likely pay higher fees, thus increasing the revenues of the service provider.

However, not every user requires every service upgrade. Users who are offered and who accept services they do not require may pay higher fees than necessary for their particular uses. Such users are vulnerable to appeals from competitors to switch service providers and enjoy the level of service more appropriate for their needs at lower cost.

Furthermore, service providers can face bottlenecks in their service delivery channels due to finite resources and fluctuations in demand, and must be careful to avoid offering services which they are not fully prepared to deliver. Such service delivery failures are likely to lead to user disappointment and potential loss of business to competition.

In the past, marketers attempting to upgrade users have commonly relied on user lists that may not reflect analysis of the user's historical utilization data to determine actual user requirements. Similarly, marketers may not have had access to current actual capacity utilization data to determine the degree to which the service provider has adequate resources to provide the offered service. Even in cases where marketers attempting to upgrade users do rely on analysis of the user's historical utilization data to determine actual user requirements, some steps commonly involve manual intervention. These steps include the analysis, the subsequent process to determine the appropriate upgrade offer, the method of communicating the offer to the user, and the method of effecting its implementation.

Hence, service providers are desirous of a means to target users for service upgrades in such a manner that the service provider is confident that the level of services offered is commensurate with the needs of the user, the service provider has the resources to deliver the proposed level of service, and the service upgrade offer can be handled in a dynamic, realtime environment, so that the upgrade is offered and implemented in a timely and efficient manner through partial or complete automation of the process.

### SUMMARY OF THE INVENTION

In one aspect, the invention features a method and system for offering a service upgrade to a user, said method comprising the steps of: storing an upgrade condition; storing a user profile for a particular service; monitoring a user's utilization of a service; updating a user profile; determining whether a service upgrade meets a predetermined condition; and offering the service upgrade to the user if the service upgrade meets the condition.

In preferred embodiments, the user profile comprises a utilization database having at least one data entry corresponding to the utilization of the service by the user. The user profile may also include a utilization parameter that describes a characteristic of the utilization database.

In other preferred embodiments, the service upgrade meets the condition if the utilization parameter equals or exceeds an upgrade criterion, if a service provider has an available capacity that equals or exceeds an upgrade capacity, or if both of these criteria are satisfied.

### BRIEF DESCRIPTION OF THE DRAWINGS

The foregoing and other features and advantages of the present invention will become more apparent in light of the following detailed description of exemplary embodiments thereof, as illustrated in the accompanying drawings, where:

FIG. 1 is a block diagram showing the components of the intelligent dynamic real time feature delivery system and their relation to the user and user interfaces;

FIG. 2 is a flow chart of the process of one embodiment of the present invention; and

FIG. 3 is an example of a user profile.

### DETAILED DESCRIPTION OF THE DRAWINGS

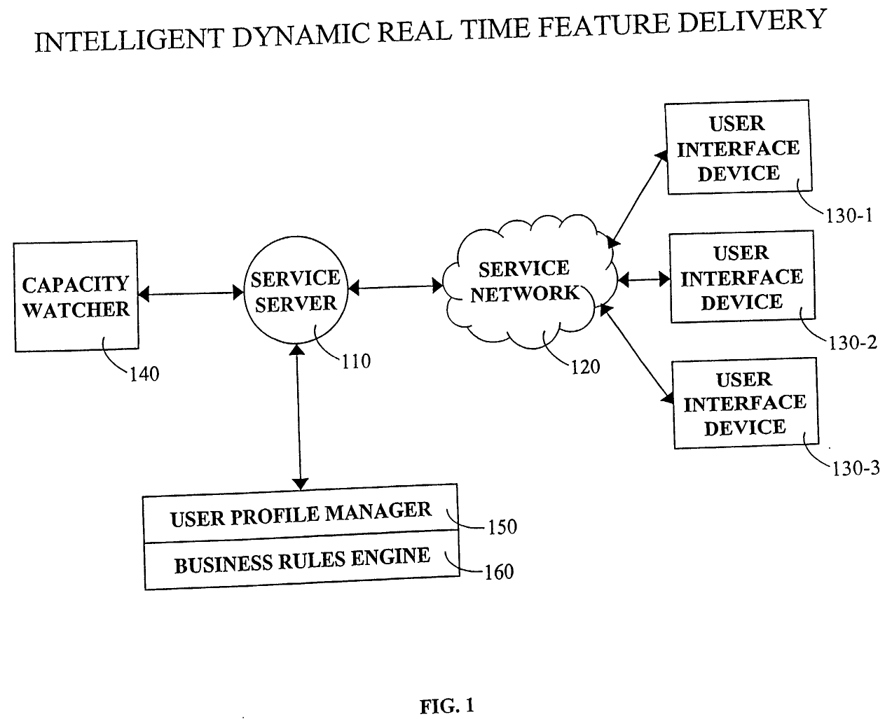

The system of the present invention derives and presents a technique for delivering additional features to a user of a service in response to the user's demonstrated pattern of service utilization. FIG. 1 is a block diagram showing the components of the system and how they relate to the user. The service server 110 is a server that manages the functioning of the intelligent dynamic real time feature delivery system. Service server 110 is in communication with the service network 120, which consists of a network of servers interconnected with each other. The service network is interconnected with a plurality of user interface devices, here represented as 130-1, 130-2, and 130-3, however, potentially consisting of a much larger number of such devices. The user interface devices may be any known network appliance, such as telephones, pagers, personal computers, personal digital assistants, or any of a variety of devices used to communicate with the Internet. Service server 110 is in communication with a user profile manager 150 and a business rules engine 160.

The user profile manager maintains records herein referred to as user profiles that are collected through the service server. Each user profile contains data reflecting the patterns displayed in the utilizations of a user. The data may be raw utilization records reflecting data regarding individual utilizations. A utilization is a quantum of service consumption. For example, in the long distance market, a utilization comprises a long distance telephone call. The user profile may also include utilization parameters that describe the patterns evident in the utilization records, including statistical measures such as means, medians, maxima, minima, correlation factors, etc.

The business rules engine is a software application that contains a set of rules governing the decisions as to whether to offer a user each of a set of potential feature upgrades or alternate service plans. There may be sets of rules concerned with the quantity of prepaid wireless minutes per month, the type of long distance plan, the number of telephone lines, and many other variables. The rules may be based on minimizing user service charges, enhancing service quality, increasing utilization of higher margin services, increasing utilization of underutilized resources, lowering operating costs, or other criteria.

The service server is also in communication with the capacity watcher 140. The function of the capacity watcher is to monitor system utilization rates with respect to capacities. The capacity watcher maintains and constantly updates data describing system utilization as it relates to system capacity. It is at all times ready to respond to a query from the service server as to whether the system can feasibly accommodate each of a set of feature upgrades or alternate plans that may be offered to the user.

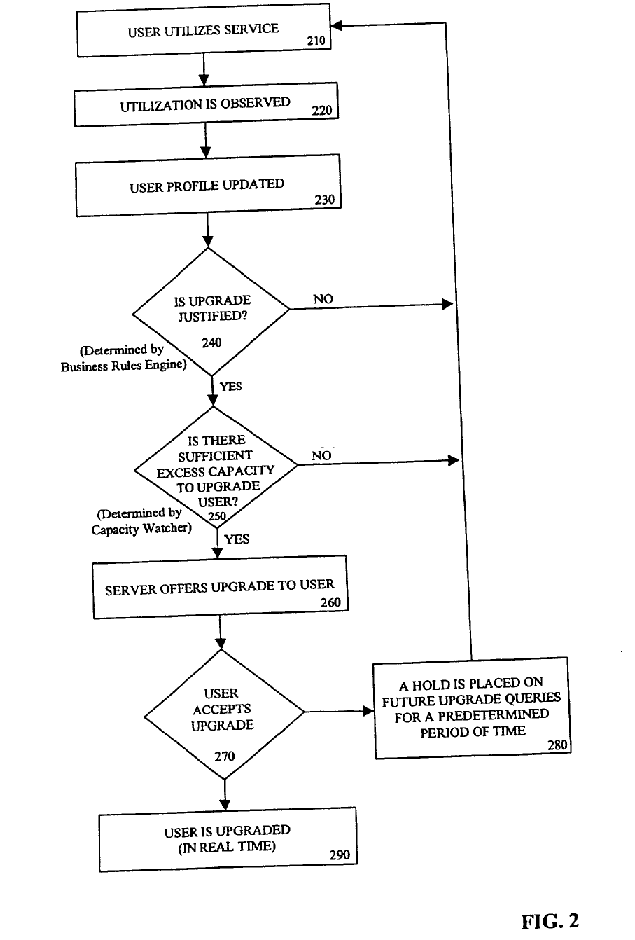

FIG. 2 is a flow diagram of one embodiment of the invention. The process starts when a user utilizes the service 210. The utilization could consist of consumption of any of a number of services including placing a phone call, accessing a website, viewing a movie, and listening to music. At this point, the user profile manager creates a user record containing data relating to certain predetermined aspects of the service, e.g., duration of the phone call, location of the party called, time of day the call was initiated 220. The record is stored and used to update the user profile 230.

The updated user record is then processed by the business rules engine to determine whether the utilization history justifies an upgrade in features or an alternate service plan 240. In preferred embodiments, the user profile manager maintains a set of utilization parameters based on characteristics of the utilization database. The business rules engine can then determine whether an upgrade is justified based on the comparison of these utilization parameters to a set of predetermined upgrade criteria. For example, there might be an upgrade criterion of 10,000 minutes for an unlimited long distance time upgrade. A user whose user profile had a utilization parameter of at least 10,000 minutes would be eligible for an offer to such an upgrade.

If no such upgrade or alternate service plan is justified as determined by the business rules engine, no offer is made to the user and the intelligent alert agent awaits the user's next utilization of the service. If such an upgrade is justified by the business rules engine, the capacity watcher is queried as to whether the system capacity can accommodate the upgrades justified by the business rules engine, taken in combination or one-by-one 250. In preferred embodiments, each service upgrade is assigned a predetermined value or formula for evaluating an upgrade capacity. The upgrade capacity is the quantity of system resources that the service upgrade would cause to be set aside for the user. If the available system capacity is at least equal to the upgrade capacity, the capacity watcher would determine that sufficient capacity for the upgrade exists. If available system capacity is less than the required upgrade capacity, the system watcher automatically sends an alert to the service provider, in order that the service provider can initiate steps to increase system capacity to meet potential upgrade requirements.

If the system capacity can not accommodate the upgrades, no offer is made to the user and the intelligent alert agent awaits the user's next utilization of the service. The intelligent agent sends an automated alert to the service provider to increase system capacity. If the system capacity can accommodate the upgrades, the user is offered the option of the upgrades 260, either automatically, or through an alerting mechanism that triggers an automated message to a sales agent to inititate a sales contact with the user, should assistance in implementing the upgrade be required. If the user does not accept the upgrade 270, a hold is placed on future upgrade queries to this user to avoid a series of “nuisance” offers to a user who is not interested in the upgrade 280. The hold is in effect for some period of time, after which the system will be free to make the offer if justified at that time.

If the user accepts the offer, the service upgrade is implented immediately by the server 290, or the upgrade is initiated by the marketing agent if manual intervention is needed to effect the upgrade. This immediate initiation of upgrades after acceptance by the user is possible because the capacity watcher has already determined that sufficient excess capacity is available to accommodate the upgrade. It is this immediate implementation, or in the case of manual intervention, immediate initiation of an upgrade process, that justifies description of the intelligent agent as being “real time.”

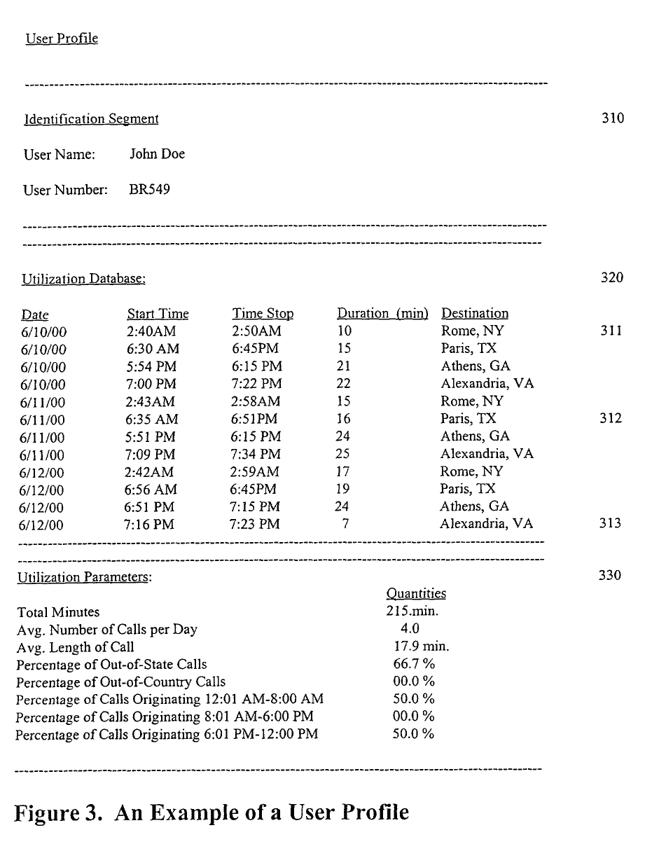

FIG. 3 depicts an example of a user profile that is maintained by the user profile manager. A user profile is created when the user registers with the service provider. The user profile contains data describing the utilization patterns of a user. The user profile may include an identification segment 310 that includes some data identifying the user. Here, the user name and user number are included. After a user completes a utilization, the user profile manager creates a utilization record that contains data regarding that utilization. In FIG. 3, utilization records 311, 312 and 313 each contain data regarding individual utilizations, in this case, telephone calls. In this case, utilization record 311 is the earliest entered and 313 is the last entered utilization record. Each utilization record contains data on “Date,” “Start Time,” “Stop Time,” “Duration” and “Destination.” In the example given, the utilization record is appended to the end of a utilization database 320 that is part of the user profile. The utilization database is a listing of a sequence of utilization records.

The user profile may also list one or more utilization parameters 330. A utilization parameter can be a statistical characterization of the data populations in the utilization database. Here, utilization parameters are recorded for total minutes (of phone calls), average number of calls per day, average duration of a call, percentage of out-of-state and out-of-country calls, and a distribution of the calls made over the course of the day.

The utilization parameters can also comprise a set of classifications of various dimensions of the data in the utilization database. An example of such a classification scheme is given in Table 1 below. Three categories are defined with respect to each of the various measures to denote a range of values demonstrated within the utilization data. Such a predefined classification scheme assists in making a rapid determination of which service upgrade options may be most appropriate for this user.

TABLE 1
An Example of a Classification Scheme for Utilization
Parameters

| Classification | Low | Medium | High |
|---|---|---|---|
| Total Minutes per | 5000 | 5000-20,000 | 20,000 |
| Month | | | |
| Number of Lines | −3 | 4-25 | 25 |
| Long Distance Minutes | 2500 | 2500-10,000 | 10,000 |
| per Month | | | |
| Morning Calls | 10 | 11-50 | 50 |
| (12:01 AM-8 AM) | | | |
| Daytime Calls (8 AM- | 10 | 11-50 | 50 |
| 6 PM) | | | |
| Evening Calls | 10 | 11-50 | 50 |
| (6:01 PM-12:00 PM) | | | |

Although the invention has been shown and described with respect to a best mode embodiment thereof, it should be understood by those skilled in the art that the foregoing and various other changes, omissions, and additions in the form and detail thereof may be made therein without departing from the spirit and scope of the invention.

1. A method for offering a service upgrade to a user comprising:
storing an upgrade condition;
storing a user profile for a particular service;
monitoring a user's utilization of the service;
updating the user profile based on said user's utilization;
determining whether the service upgrade meets the upgrade condition based on said user profile; and
offering in real time the service upgrade to the user if the service upgrade meets the upgrade condition.

2. The method of claim 1 wherein the user profile comprises a utilization database having at least one data entry corresponding to the user's utilization of the service.

3. The method of claim 1 wherein the user profile comprises a utilization parameter that describes a characteristic of the utilization database.

4. The method of claim 3 wherein the service upgrade meets the upgrade condition if the utilization parameter equals or exceeds an upgrade criterion.

5. The method of claim 1 wherein the service upgrade meets the upgrade condition if a service provider has an available capacity that equals or exceeds an upgrade capacity.

6. The method of claim 1 wherein the service upgrade meets the upgrade condition if the utilization parameter equals or exceeds an upgrade criterion and a service provider has an available capacity that equals or exceeds an upgrade capacity.

7. A system for offering a service upgrade to a user comprising:
a server adapted for storing an upgrade condition;
storing a user profile for a particular service;
monitoring a user's utilization of the service;
updating the user profile based on said user's utilization;
determining whether a service upgrade meets the upgrade condition based on said user profile; and
offering in real time the service upgrade to the user if the service upgrade meets the upgrade condition.

8. The system of claim 7 wherein the user profile comprises a utilization database having at least one data entry corresponding to the user's utilization of the service.

9. The system of claim 7 wherein the user profile comprises a utilization parameter that describes a characteristic of the utilization database.

10. The system of claim 9 wherein the service upgrade meets the upgrade condition if the utilization parameter equals or exceeds an upgrade criterion.

11. The method of claim 7 wherein the service upgrade meets the upgrade condition if a service provider has an available capacity that equals or exceeds an upgrade capacity.

12. The method of claim 7 wherein the service upgrade meets the upgrade condition if the utilization parameter equals or exceeds an upgrade criterion and a service provider has an available capacity that equals or exceeds an upgrade capacity.
